(19) United States
(12) Patent Application Publication
(10) Pub. No.: US 2016/0110650 A1
(43) Pub. Date: Apr. 21, 2016

(54) ADVANCED CONTEXT-BASED DRIVER SCORING

(71) Applicant: IMS SOLUTIONS, INC., Schaumburg, IL (US)

(72) Inventors: Otman A. Basir, Waterloo (CA); William Ben Miners, Guelph (CA); Akrem Saad El-Ghazal, Waterloo (CA); Seyed Hamidreza Jamali, Waterloo (CA)

(21) Appl. No.: 14/556,726

(22) Filed: Dec. 1, 2014

Related U.S. Application Data
(60) Provisional application No. 61/910,239, filed on Nov. 29, 2013.

(51) Int. Cl. G06N 5/04; G06N 99/00

(52) U.S. Cl. CPC G06N 5/048; G06N 99/005

(57) ABSTRACT

A context-based driver scoring system evaluates various aspects of driving and parking behavior while taking into account context-related conditions. The inputs to the system may include driving data, the conditions specifying the current context, and the configuration parameters data. The outputs of the system may be driving scores that characterize the performance of the driver according to the given context. In particular, first the context module is used to calculate a context factor that enables applying the effect of the context conditions to the driving scores.

### BACKGROUND OF THE INVENTION

Modern telematic technologies enable collection of a wide range of driving data from vehicles. These driving data are valuable in characterizing the driving behaviors of a driver. This may be done for purposes of calculating insurance, monitoring young drivers, monitoring employee drivers, etc.

### SUMMARY OF THE INVENTION

A context-based driver scoring system evaluates various aspects of driving and parking behavior while taking into account context-related conditions. The inputs to the system may include driving data, the conditions specifying the current context, and the configuration parameters data.

The outputs of the system may be driving scores that characterize the performance of the driver according to the given context. In particular, first the context module is used to calculate a context factor that enables applying the effect of the context conditions to the driving scores.

Then, the scoring module calculates each of the scores according to the collected driving data and the current context of driving. In one embodiment of the system, scores characterizing seven different aspects of driving performance are characterized as listed below:

Overspeed

Harsh acceleration

Harsh braking

Harsh cornering

Harsh cabin noise

Aggression

Anticipation

Generally, the system may generate a driver score. The driver score may be based on driving behavior. The driving behavior may include one or more of braking, acceleration, cornering, lane changes, speed, parking events, and cabin noise. Aggregate scores may be derived from individual scores, including one or more of driver aggression and driver anticipation. External context may influence the driver score. The external context may include one or more of weather, road conditions, time of day, road network attributes, vehicle class, vehicle mass, vehicle dimensions, location, school zone proximity, work zone proximity, restricted zones, vehicle engine type, and vehicle health. The level of influence from context may be defined using membership functions.

The score may be influenced by driver demographics. The external context may include one or more dynamic realtime conditions including surrounding vehicle proximity, traffic, and traffic light status. The external context may include dynamic historical conditions for the route traveled including surrounding vehicle proximity and traffic. The score may be influenced by the metadata.

The disclosure provides a system that automatically detects vehicle parking scenarios. The parking scenarios may include single or multiple parking events. The system may automatically classify vehicle parking scenarios. The parking scenarios may include one or more of forward parallel, reverse parallel, forward perpendicular, reverse perpendicular, and diagonal.

These and other features of the invention can be best understood from the following specification and drawings.

### BRIEF DESCRIPTION OF THE DRAWINGS

FIG. 1 is a schematic of example hardware that could be used to perform the present invention.

FIG. 2 schematically illustrates the state diagram for the scoring system.

FIG. 3 schematically illustrates an example 2D membership function.

FIG. 4 schematically illustrates the distribution of braking events.

FIGS. 5a-e schematically illustrates parking patterns.

FIGS. 6a-d illustrate parking practice events.

FIG. 7 illustrates distance calculations.

FIG. 8 illustrates a specific distance difference.

FIG. 9 illustrates a sample journey with two single parallel parking events.

FIG. 10 illustrates a sample journey with two multiple parallel parking events.

### DETAILED DESCRIPTION OF THE PREFERRED EMBODIMENT

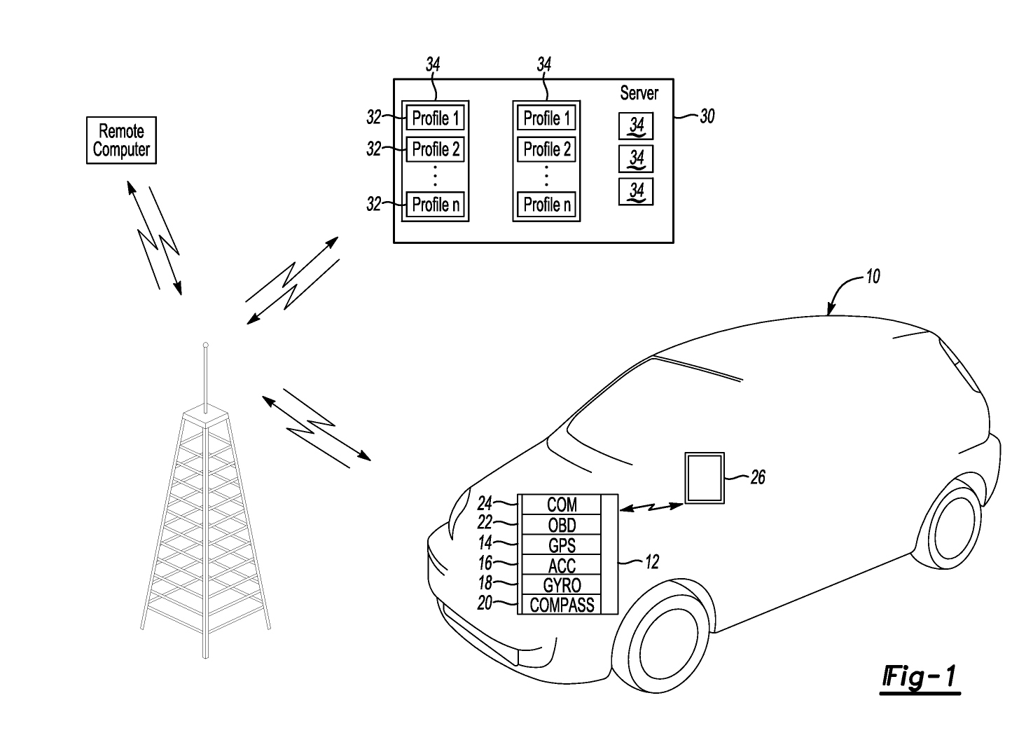

Referring to FIG. 1, a motor vehicle 10 includes a plurality of data gathering devices that communicate information to an appliance 12 installed within the vehicle 10. The example data gathering devices include a global positioning satellite (GPS) receiver 14, a three-axis accelerometer 16, a gyroscope 18 and an electronic compass 20, which could be housed within the appliance 12 (along with a processor and suitable electronic storage, etc. and suitably programmed to perform the functions described herein). As appreciated, other data monitoring systems could be utilized within the contemplation of this invention. Data may also be collected from an onboard diagnostic port (OBD) 22 that provides data indicative of vehicle engine operating parameters such as vehicle speed, engine speed, temperature, fuel consumption (or electricity consumption), engine idle time, car diagnostics (from OBD) and other information that is related to mechanical operation of the vehicle. Moreover, any other data that is available to the vehicle could also be communicated to the appliance 12 for gathering and compilation of the operation summaries of interest in categorizing the overall operation of the vehicle. Not all of the sensors mentioned here are necessary, however, as they are only listed as examples.

The appliance 12 may also include a communication module 24 (such as cell phone, satellite, wi-fi, etc.) that provides a connection to a wide-area network (such as the internet). Alternatively, the communication module 24 may connect to a wide-area network (such as the internet) via a user's cell phone 26 or other device providing communication.

The in vehicle appliance 12 gathers driving data from the various sensors mounted within the vehicle 10 and stores that data. The in vehicle appliance 12 transmits this driving data (or summaries or analyses thereof) as a transmission signal through a wireless network to a server 30 (also having at least one processor and suitable electronic storage and suitably programmed to perform the functions described herein). The server 30 utilizes the received driving data to categorize vehicle operating conditions in order to determine or track vehicle use. This driving data can be utilized for tracking and determining driver behavior, such as for insurance premiums for the motor vehicle, tracking data utilized to determine proper operation of the vehicle and other information that may provide value such as alerting a maintenance depot or service center when a specific vehicle is in need of such maintenance. Driving events and driver behavior are recorded by the server 30, such as fuel and/or electricity consumption, speed, driver behavior (acceleration, speed, etc.), distance driven and/or time spent in certain insurance-risk coded geographic areas. For example, the on-board appliance 12 may record the amount of time or distance in high-risk areas or low-risk areas, or high-risk vs. low risk roads. The on-board appliance 12 may collect and transmit to the server 30 (among other things mentioned herein): Speed, Acceleration, Distance, Fuel consumption, Engine Idle time, Car diagnostics, Location of vehicle, Engine emissions, etc.

The server 30 includes a plurality of profiles 32, each associated with a vehicle 10 (or alternatively, with a user). Among other things, the profiles 32 each contain information about the vehicle 10 (or user) including some or all of the gathered driving data (or summaries thereof). Some or all of the data (or summaries thereof) may be accessible to the user via a computer 32 over a wide area network (such as the internet) via a policyholder portal, such as fuel efficiency, environmental issues, location, maintenance, etc. The user can also customize some aspects of the profile 32.

It should be noted that the server 30 may be numerous physical and/or virtual servers at multiple locations. The server 30 may collect driving data from appliances 12 from many different vehicles 10 associated with a many different insurance companies. Each insurance company (or other administrator) may configure parameters only for their own users. The server 30 permits the administrator of each insurance company to access only data for their policyholders. The server 30 permits each policyholder to access only his own profile and receive information based upon only his own profile.

The server 30 may not only reside in traditional physical or virtual servers, but may also coexist with the on-board appliance, or may reside within a mobile device. In scenarios where the server 30 is distributed, all or a subset of relevant information may be synchronized between trusted nodes for the purposes of aggregate statistics, trends, and geo-spatial references (proximity to key locations, groups of drivers with similar driving routes).

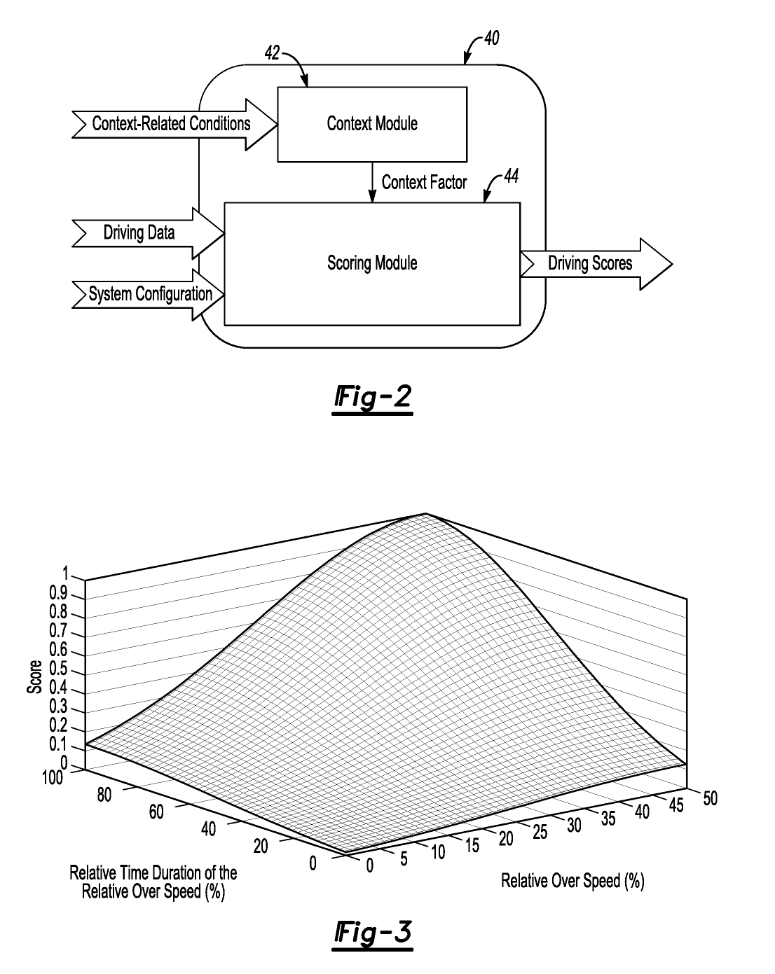

FIG. 2 illustrates a schematic diagram of the advanced context-based driver scoring system 40 which may be located on the server 30 or a different server based upon the data received from server 30. Alternatively, the scoring system 40 may be located on the vehicle 10 in the appliance 12. The context-based driver scoring system 40 includes a context module 42 and a scoring module 44. The inputs to the system 40 include three categories of data, namely, the driving data, the conditions specifying the current context, and the system configuration parameters data.

The outputs of the system 40 are a set of driving scores that characterize the performance of the driver according to the given context. In particular, first the context module 42 is used to calculate a context factor that enables applying the effect of the context conditions to the driving scores.

Then, the scoring module 44 calculates each of the scores according to the collected driving data and the current context of driving. In one embodiment of the system, scores characterizing seven different aspects of driving performance are characterized as listed below:

Overspeed

Harsh acceleration

Harsh braking

Harsh cornering

Harsh cabin noise

Aggression

Anticipation

Generally, the system may generate a driver score. The driver score may be based on driving data. The driving data may include one or more of braking, acceleration, cornering, lane changes, speed, parking events, and cabin noise. An aggregate score may be derived from individual scores, including one or more of driver aggression and driver anticipation. External context may influence the driver score. The external context may be received from external sources such as other servers or websites, from sensors on the vehicle, or from vehicles near the vehicle. The external context may include one or more of weather, road conditions, time of day, road network attributes, vehicle class, vehicle mass, vehicle dimensions, location, school zone proximity, work zone proximity, restricted zones, vehicle engine type, and vehicle health. Some of the external context depends on the vehicle's current location (e.g. weather, time of day, road network attributes, road conditions) which is received by the server 30 from the onboard appliance 12. The level of influence from context may be defined using membership functions.

The score may be influenced by driver demographics. The external context may include one or more dynamic realtime conditions including surrounding vehicle proximity, traffic, and traffic light status. The external context may include dynamic historical conditions for the route traveled including surrounding vehicle proximity and traffic. The score may be influenced by the metadata.

The disclosure also provides a system that automatically detects vehicle parking scenarios. The parking scenarios may include single or multiple parking events. The system may automatically classify vehicle parking scenarios. The parking scenarios may include one or more of forward parallel, reverse parallel, forward perpendicular, reverse perpendicular, and diagonal.

The Driver Scoring Algorithms

The scoring module can employ different transformations from input variables to resulting score. In one embodiment, this transformation occurs using membership functions. The notion of membership function provides an efficient and flexible approach to compute driving scores based on expert knowledge. The membership function has several parameters that can be easily tuned to adopt expert knowledge.

Overspeed Scoring Algorithm

The driver overspeed score is calculated relative to the posted speed limit. The score of 25 km/h absolute over speed in a road with 50 km/h posted speed limit has a worse score than the same over speed (25 km/h) in a road with 100 km/h posted speed limit. The disclosed algorithm monitors the speed of the vehicle over the course of a trip and computes a single output, i.e. overspeed score, by following the steps below:

Use the collected vehicle speed samples to compute the relative_over_speed as

relative_over_speed=(vehicle speed−posted speed limit)

Use the timestamps of the collected vehicle speed samples to compute the relative_time_duration of over speeding as

relative_time_duration=(time duration of over speed/total trip time)*100

Feed each relative over speeding x along with its corresponding time duration y to a 2D membership function to obtain the individual over speeding scores as

Over_speed_score=A*ê(−0.5*((x−x )̅/δ_x)̂2*((y−y )̅/δ_y)̂2)

Where

A is a constant term used to normalize the score,

The x and y denote the maximum allowed relative overspeed and maximum relative time, respectively,

The δ_x and δ_y denote the relative overspeed and relative time standard deviation, respectively.

Compute the overall overspeed score as the weighted sum of the individual scores.

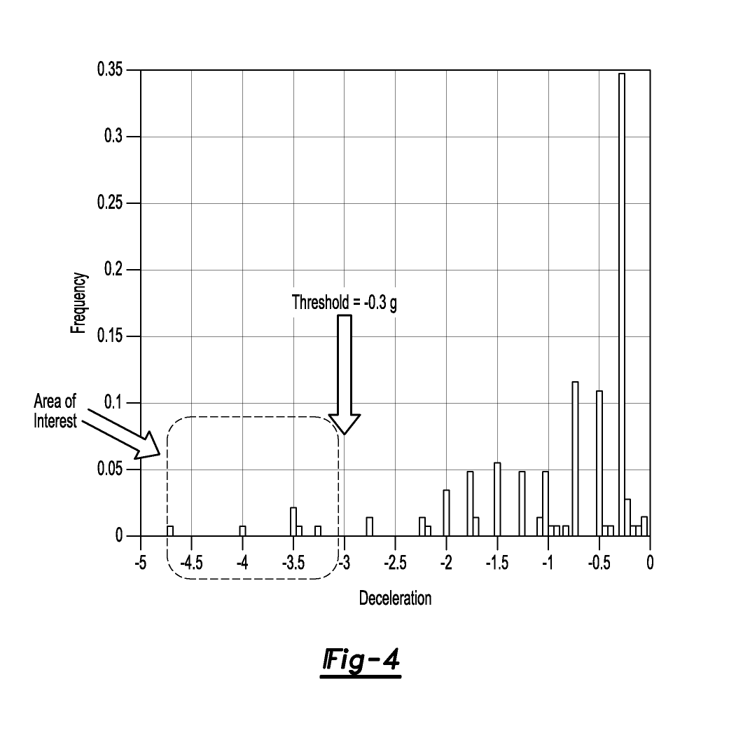

FIG. 3 shows an exemplary 2D membership function used for overspeed scoring algorithm. In one preferred embodiment of the disclosed algorithm, the weights can be determined according to the temporal frequency of overspeed events.

Harsh Acceleration Scoring Algorithm

The disclosed algorithm monitors the acceleration of the vehicle over the course of a trip and computes a single output, i.e. harsh acceleration score, by following the steps below

Use the collected vehicle acceleration samples to compute the relative_harsh_acceleration as:

relative_harsh_acceleration=(harsh acceleration magnitude−harsh acceleration threshold)

Feed each relative harsh acceleration x to a 1D membership function to obtain the individual harsh acceleration scores as

Harsh_acceleration_score=A*ê(−0.5*((x−x )̅/δ_x)̂2)

Where

A is a constant term used to normalize the score,

The x denotes the maximum allowed relative harsh acceleration,

The δ_x denotes the standard deviation of harsh acceleration.

Compute the overall harsh acceleration score as the weighted sum of the individual scores.

Harsh Braking Scoring Algorithm

The disclosed algorithm monitors the deceleration of the vehicle over the course of a trip and computes a single output, i.e. harsh braking score, by following the steps below

Use the collected vehicle deceleration samples to compute the relative_harsh_braking as

relative_harsh_braking=(harsh braking magnitude−harsh braking threshold)

Feed each relative harsh braking x to a 1D membership function to obtain the individual harsh braking scores as

Harsh_braking_score=A*ê(−0.5*((x−x )̅/δ_x)̂2)

Where

A is a constant term used to normalize the score,

The x denotes the maximum allowed relative harsh braking,

The δ_x denotes the standard deviation of harsh braking

Compute the overall harsh braking score as the weighted sum of the individual scores.

Harsh Cornering Scoring Algorithm

The disclosed algorithm monitors the lateral acceleration of the vehicle over the course of a trip and computes a single output, i.e. harsh cornering score, by following the steps below.

Use the collected vehicle lateral acceleration samples to compute the relative_harsh_cornering as

relative_harsh_cornering=(harsh lateral acceleration magnitude−harsh cornering threshold)

Feed each relative harsh cornering x to a 1D membership function to obtain the individual harsh cornering scores as

Harsh_cornering_score=A*ê(−0.5*((x−x )̅/δ_x)̂2)

Where

A is a constant term used to normalize the score,

The x denotes the maximum allowed relative harsh cornering,

The δ_x denotes the standard deviation of harsh cornering.

Compute the overall harsh cornering score as the weighted sum of the individual scores.

Harsh Cabin Noise Scoring Algorithm

The disclosed algorithm monitors the noise within the vehicle's cabin over the course of a trip and computes a single output, i.e. harsh cabin noise score, by following the steps below.

Use the collected vehicle cabin noise samples to compute the relative_harsh_cabin_noise as

relative_harsh_cabin_noise=(cabin noise magnitude−harsh cabin noise threshold)

Feed each relative harsh cabin noise x to a 1D membership function to obtain the individual harsh cabin noise scores as

Harsh_cabin_noise_score=A*ê(−0.5*((x−x )̅/δ_x)̂2)

Where

A is a constant term used to normalize the score,

The x denotes the maximum allowed relative harsh cabin noise,

The δ_x denotes the standard deviation of harsh cabin noise.

Compute the overall harsh cabin noise score as the weighted sum of the individual scores.

Aggression Scoring Algorithm

The disclosed algorithm monitors several of the context-based driver scores, namely, the overspeed, harsh acceleration, harsh braking, and harsh cornering scores, over the course of a trip and computes a single output, i.e. driver aggression score, as a weighted sum of the aforementioned scores.

Anticipation Scoring Algorithm

The disclosed algorithm monitors the deceleration of the vehicle along with the overspeed score over the course of a trip and computes a single output, i.e. driver anticipation score, by following the steps below.

Use the vehicle deceleration samples for the entire trip to compute the normalized distribution of braking events throughout the trip, i.e. the vehicle deceleration for each braking event versus the frequency of that braking event as shown in FIG. 4.

Calculate the driver braking score as the total area of the portion of the normalized distribution where the deceleration magnitude is less than the braking threshold. FIG. 4 shows this area of interest for an exemplary trip with braking threshold of −0.3 g.

Compute the driver anticipation score as the weighted sum of the aforementioned overspeed score and the computed braking score.

Incorporating Context-Related Conditions

The context module accepts context-related conditions as input and computes a single output, i.e. context factor, which is then embedded into the scoring algorithms in order to incorporate the effect of context.

In this example, the discount factor is normalized to be between zero and one, where the lower the context factor value, the worse, i.e. more dangerous, the driving context.

In the disclosed system the context factor can be computed by a variety of methods. An exemplary approach can be based on lookup table to compute the discount factor. The example Table 1 below contains four types of environmental conditions, namely, rain, snow, fog, and ice, and their corresponding discount factors. In the table the 1 represents the availability of the condition. The lookup table mechanism provides a flexible mapping approach applicable to an arbitrary set of context-related conditions and easily customizable according to the requirements of the application at hand.

TABLE 1
An exemplary embodiment of the context module as a lookup table

| | | | | Discount |
|---|---|---|---|---|
| Rain | Snow | Fog | Ice | Factor |
| 0 | 0 | 0 | 0 | 1 |
| 0 | 0 | 0 | 1 | 0.9 |
| 0 | 0 | 1 | 0 | 0.9 |
| 0 | 0 | 1 | 1 | 0.85 |
| 0 | 1 | 0 | 0 | 0.9 |
| 0 | 1 | 0 | 1 | 0.85 |
| 0 | 1 | 1 | 0 | 0.85 |
| 0 | 1 | 1 | 1 | 0.8 |
| 1 | 0 | 0 | 0 | 0.9 |
| 1 | 0 | 0 | 1 | 0.85 |
| 1 | 0 | 1 | 0 | 0.85 |
| 1 | 0 | 1 | 1 | 0.8 |
| 1 | 1 | 0 | 0 | 0.85 |
| 1 | 1 | 0 | 1 | 0.8 |
| 1 | 1 | 1 | 0 | 0.75 |
| 1 | 1 | 1 | 1 | 0.7 |

The output of the context module 42, i.e. the context-based factor, is used to adjust the operation of driver scoring algorithms in scoring module 44. In one embodiment of the disclosed system the context factor is used to discount the threshold values used in computing the relative parameters of scoring algorithms. For instance, in the overspeed algorithm the relative_over_speed is computed as

Relative_over_speed=((vehicle speed−posted speed limit*context factor)/(posted speed limit*context factor))*100

All other relative parameters used in the scoring algorithms, namely, relative_harsh_acceleration, relative_harsh_braking, relative_harsh_cornering, and relative_harsh_cabin_noise are also computed in a similar fashion (e.g. reducing the threshold to which the driving data is compared). The effect achieved by this discounting procedure is to increasingly penalize the driving scores as the context factor becomes smaller.

In another exemplary embodiment, the context factor is used to modify standard deviation parameters of the scoring membership functions. For instance, in the harsh braking algorithm the standard deviation of harsh braking is updated as

δ_x=δ_x/context factor

The standard deviations used in all other scoring membership functions are similarly updated using the computed context factor. The end result is to enlarge the standard deviation for smaller context factors, hence increasingly penalize the driving scores.

Optionally, both the threshold and standard deviation could be modified based upon the context factor.

Selected System Configuration Options

This section presents the parameters involved in the operation of the context-based driver scoring system. Table 2 provides an overview of the available parameters. These parameters affect the overall performance of the system and thus are tuned through careful empirical analysis for each application.

TABLE 2
Summary of the parameters of the disclosed method

| Parameter Name | Description |
|---|---|
| Max_over_speed | Maximum allowed relative overspeed |
| Max_relative_time | Maximum relative time |
| Var_relative_over_speed | Variance of relative overspeed |
| Var_relative_time | Variance of relative time |
| Max_relative_hasrh_acceleratiom | Maximum allowed relative harsh acceleration |
| Var_harsh_acceleration | Variance of harsh acceleration |
| Harsh_acceleration_thr | Harsh acceleration threshold |
| Harsh_braking_thr | Harsh braking threshold |
| Harsh_cornering_thr | Harsh cornering acceleration threshold |
| Max_relative_harsh_braking | Maximum allowed relative harsh braking |
| Var_harsh_braking | Variance of harsh braking |
| W_braking_anticipation | Braking weight for anticipation |
| W_speed_anticipation | Overspeeding weight for anticipation |
| W_speed_aggression | Overspeeding weight for aggression |
| W_harsh-accelereation_aggression | Harsh acceleration weight for aggression |
| W_harsh-braking_aggression | Harsh braking weight for aggression |
| W_harsh-cornering_aggression | Harsh cornering weight for aggression |
| Braking_thr_anticipatiom | Braking threshold for anticipation |
| Max_relative_harsh_cornering_acceleration | Maximum allowed relative harsh cornering |
| | acceleration |
| Var_harsh_cornering_acceleration | Variance of harsh cornering acceleration |
| Max_relative_harsh_cabin_noise | Maximum allowed relative harsh cabin noise |
| Var_harsh_cabin_noise | Variance of harsh cabin noise |
| Harsh_cabin_noise_thr | Harsh cabin noise threshold |
| Harsh_acceleration_normalization | Harsh acceleration normalization term |
| Harsh_braking_normalization | Harsh braking normalization term |
| Harsh_cornering_normalization | Harsh cornering normalization term |
| Harsh_cabin_noise normalization | Harsh cabin noise normalization term |
| Over_speed_normalization | Overspeeding normalization term |

Parking Characterization

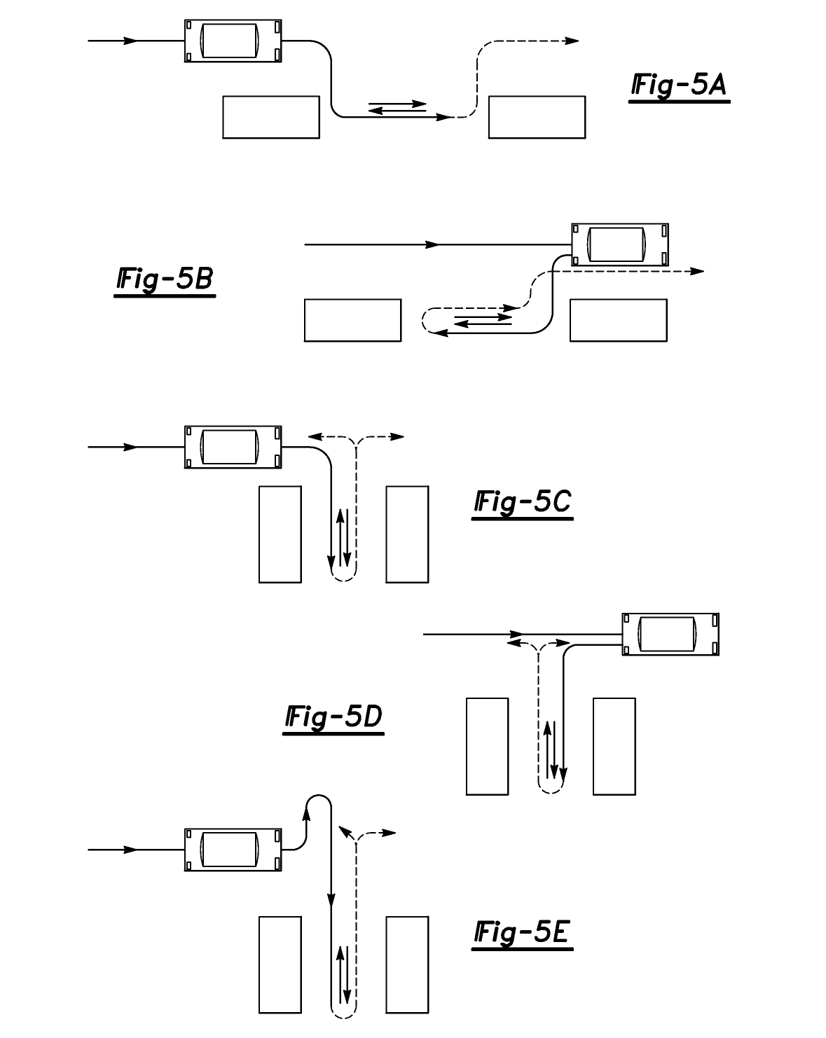

In addition to driving behavior, it is valuable to accurately capture and characterize individual parking events. In this embodiment, four different parking events are characterized based on vehicle movement: Forward Parallel (FIG. 5a), Reverse Parallel (FIG. 5b), Forward Perpendicular (FIG. 5c), and Reverse Perpendicular (FIGS. 5d and 5e). The approach can also be extended to incorporate additional parking styles.

While accelerometer and GNSS based information is available, accelerometer information is often inadequate on its own to characterize the fine nuances of vehicle acceleration as the vehicle completes a parking scenario. Both accelerometer and GNSS based information is leveraged in this embodiment of the system.

Parallel parking detection focuses on locating the specific sequence of events from stopping alongside a vehicle, reversing or driving forward into a parking spot, steering the vehicle, fine tuning the approach, stopping the vehicle, then leaving the parking spot for a subsequent journey or to continue the current journey.

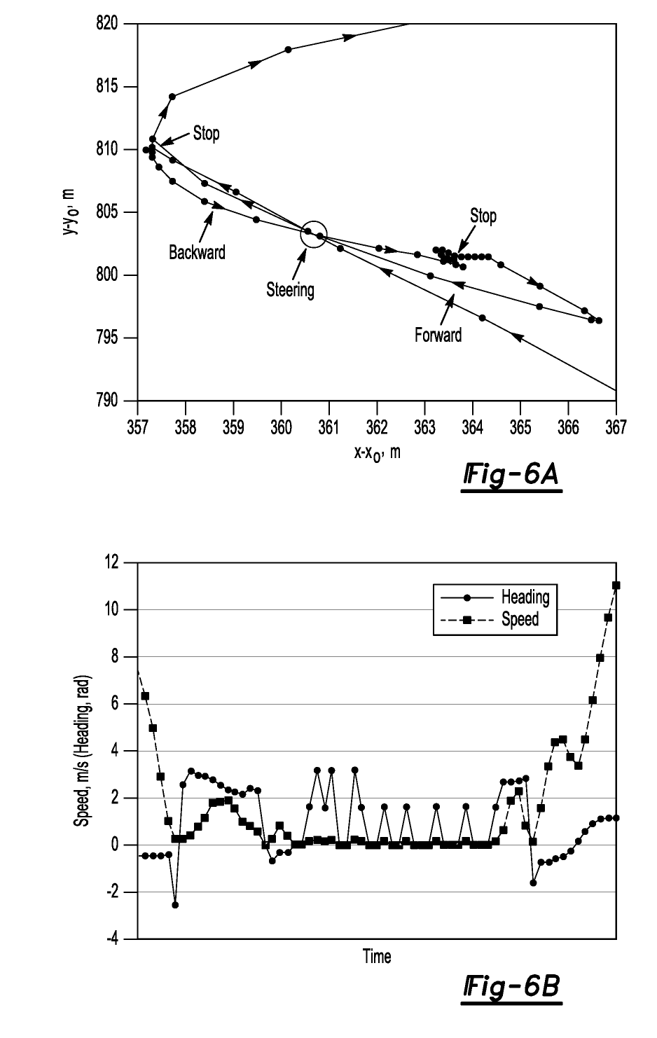

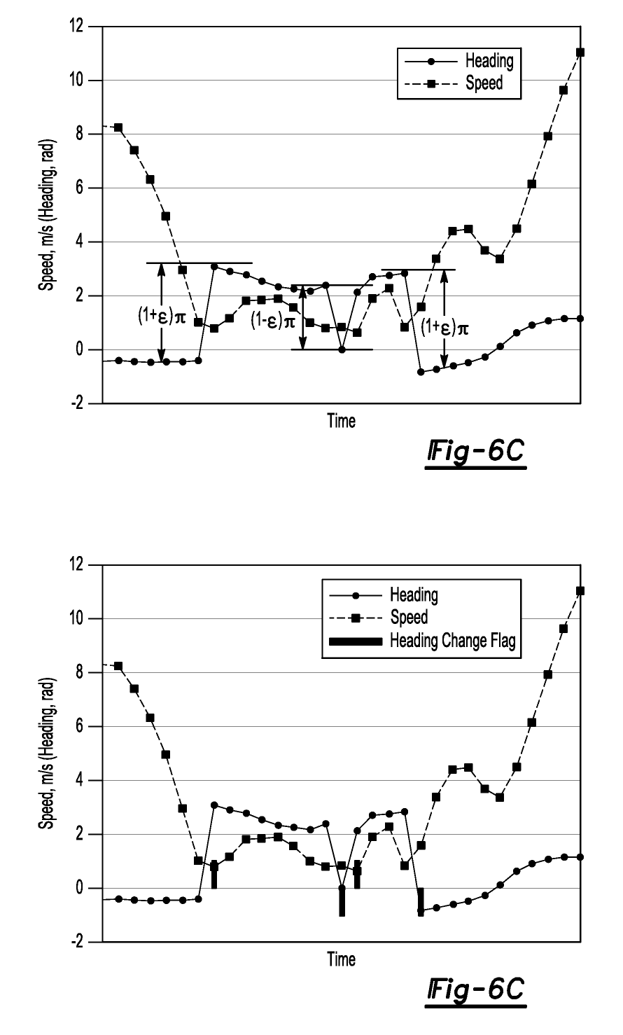

FIG. 6 (a) and (b) show positional information for a parallel parking event including low speed noise that is filtered as part of the parking characterization process. FIG. 6 (c) illustrates the heading and speed profiles for the same event as FIG. 6 (a).

The approach to detect parking events is based on distance calculation. This approach is based on calculating the distance between two points with w seconds apart using two different methods. The first one calculates the Euclidean distance between start and end points Pᵢ=(xᵢ, yᵢ) and Pi+w=(xi+w, yi+w) directly as d₁=sqrt ((x_{i+w}−xᵢ)₂+(y_{i+w}−yᵢ)₂).

The second one computes the total distance between these two points by summing up the piecewise distances between intermediate points calculated based on the corresponding speed values as follows: d2=Σ speed(l)*_t, l=i, . . . , w, where t is the sampling time of the GPS data.

Note that for the straight driving path these two distances are almost the same. However, for curvy paths they will diverge from each other. This is depicted in FIG. 5 pictorially. It is obvious that for a parallel parking event, a part of the path corresponding to this event has loop and the difference between loops will increase considerably.

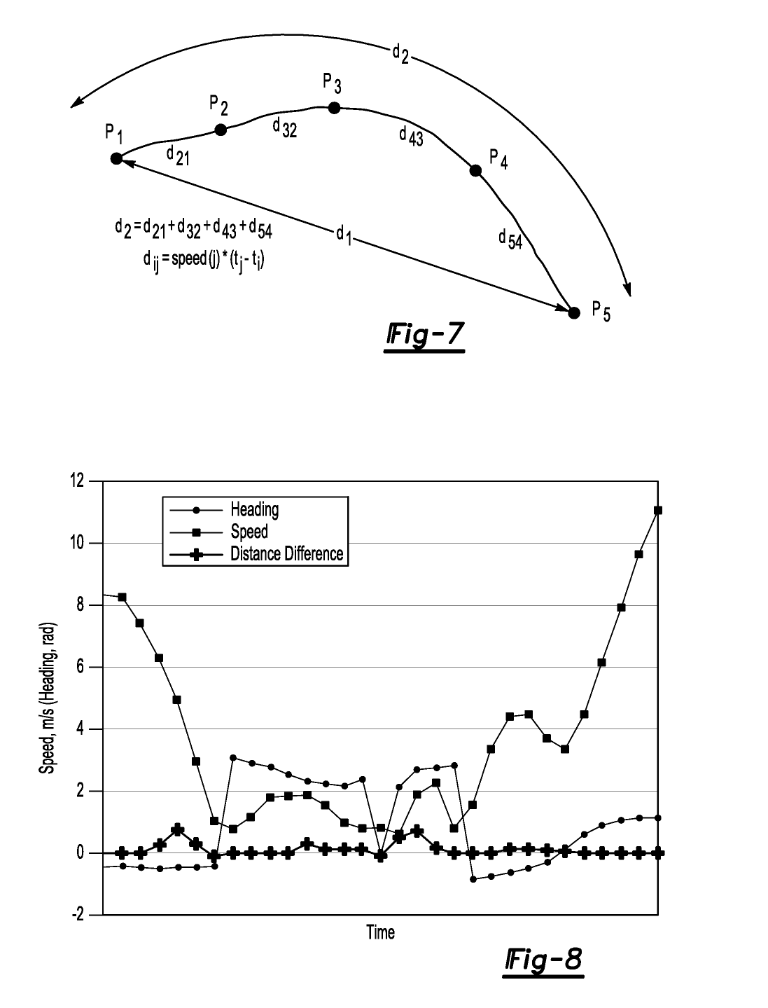

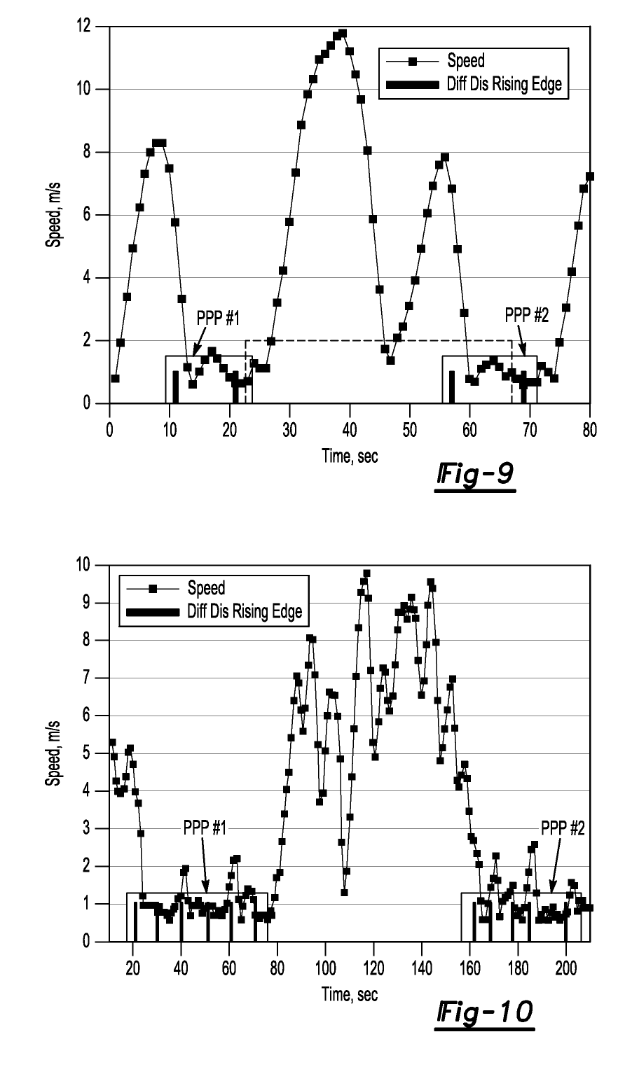

FIG. 7 shows the difference between d1 and d2 for the parking event described in FIG. 6 (a). The parallel parking event is detected by monitoring the normalized distance difference ((d2−d1)/d2) with a preset window size. FIG. 8 illustrates the distance difference, a measure of the deviations in the path between two points in the parking maneuver. This measure is important to discriminate between specific parking activities. Changes in the distance difference measure are used to accurately identify single parallel parking events separated by normal driving as shown in FIG. 9, and also useful to identify scenarios where the driver makes multiple attempts to parallel park as shown in FIG. 10.

The frequency and proximity of distance difference measures are used to identify specific parking time windows. The distance difference between two points that are dis_win_size apart using the difference distance calculation mechanisms identify candidate parking events. Events occurring within a short time interval are considered to be part of the same parking event. To help minimize false positives, time intervals of approximately 20 seconds may be used. The logic used to detect parking maneuvers uses a combination of distance difference patterns and time based criteria. A sharp rise in the distance difference is used to trigger the start of a parking maneuver, and a time-based criteria is used in combination with subsequent distance difference measures to detect the end of the parking maneuver.

In the example embodiment, the driving scores are calculated for each journey or trip (e.g. ignition on to ignition off). Alternatively, the driving scores may be calculated in real time (or near real time), being updated with new information during a journey so that feedback can be provided to the driver during driving. The driving scores may also be calculated for each parking event separately. The context factors may be applied to the parking events as well. For example, parallel parking in the snow or dark will be scored differently from parallel parking in warm weather during daylight. Aggressive maneuvers during parking are monitored and included in the assessment during parking.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A method for evaluating driving behavior including the steps of:
a) receiving in a computer driving data indicating driving behavior of a driver;
b) receiving in the computer context data indicating conditions in which the driving behavior occurred; and
c) evaluating the driving behavior based upon the driving data and based upon the context data.

2. The method of claim 1 wherein the driving data includes acceleration.

3. The method of claim 1 wherein the driving data includes hard braking.

4. The method of claim 1 wherein the driving data includes speed.

5. The method of claim 1 wherein the context data includes weather conditions.

6. The method of claim 1 wherein said step c) includes comparing the driving data to a standard and includes altering the standard based upon the context data.

7. The method of claim 1 wherein said step c) includes comparing the driving data to a standard in light of a standard deviation and wherein said step c) includes altering the standard deviation based upon the context data.

8. The method of claim 1 wherein the driving data includes acceleration, hard braking and speed and wherein the context data includes weather conditions.

9. The method of claim 8 wherein said step c) includes comparing the driving data to a standard and includes altering the standard based upon the context data.

10. The method of claim 8 further including the step of monitoring driving behavior with a plurality of sensors in the vehicle to generate the driving data.

11. The method of claim 10 further including the step of transmitting the driving data from the vehicle to the computer.

12. A system for evaluating driving behavior including a computer configured to receive driving data indicating driving behavior of a driver, the computer configured to receive context data indicating conditions in which the driving behavior occurred, and the computer configured to evaluate the driving behavior based upon the driving data and based upon the context data.

13. The system of claim 12 wherein the driving data includes acceleration, hard braking and speed and wherein the context data includes weather conditions.

14. The system of claim 13 wherein the computer is configured to compare the driving data to a standard and to alter the standard based upon the context data.

15. The system of claim 14 further including a plurality of sensors in the vehicle to generate the driving data based upon driving behavior.

16. The system of claim 15 further including a transmitter configured to transmit the driving data from the vehicle to the computer.

17. A method for monitoring driving including the steps of:
a) receiving driving data; and
b) evaluating the driving data to determine that a parking event has occurred.

18. The method of claim 17 further including the step of gathering the driving data with accelerometers and a GNSS receiver.

19. The method of claim 18 wherein the driving data includes heading and speed information.

20. The method of claim 19 further including the step of characterizing a type of parking event that has occurred from one of a plurality of parking event types.
